(19) United States
(12) Patent Application Publication
(10) Pub. No.: US 2012/0128547 A1
(43) Pub. Date: May 24, 2012

(54) Plant and Method for Treating Moist Organic and/or Inorganic Material

(75) Inventor: Andre Grosser, Neumarkt (DE)

(73) Assignee: HUBER SE, Berching (DE)

(21) Appl. No.: 13/386,759

(22) PCT Filed: Jul. 23, 2010
(86) PCT No.: PCT/EP2010/060754

§ 371 Date: Jan. 24, 2012

(30) Foreign Application Priority Data
Jul. 24, 2009 (DE) 10 2009 027 990.3

(51) Int. Cl. B01J 19/00

(52) U.S. Cl. 422/291

(57) ABSTRACT

The invention relates to a plant for treating moist organic and/or inorganic material, particularly in the form of sludge, for example sewage sludge, wherein the plant comprises a drying surface for the material to be treated and a transfer station connecting thereto for the at least partially dried material. According to the invention, the plant comprises, downstream from the drying surface, a device for sanitizing the material.

This invention refers to a plant for treating moist organic and/or inorganic material, especially having the form of sludge, such as sewage sludge in particular, wherein the plant has a drying surface for the material to be treated and a collection point downstream therefrom for the at least partially dried material. According to the invention, the plant has a device for sanitizing the material installed downstream from the drying surface.

Furthermore, a method for treating moist organic and/or inorganic material—especially in the form of sludge, such as sewage sludge—is suggested, wherein the method comprises the at least partial drying of the material and is characterized by the fact that the material is sanitized right after drying.

Since sewage sludge, in particular, is heavily contaminated with microorganisms that produce a strong odor owing to their corresponding metabolism or can also be detrimental to health, the sewage sludge must be sanitized after drying, i.e. treated with heat or other energy sources such as UV radiation, for example. According to the state of the art, this treatment takes place at a separate location, so that there are extra transportation and storage expenses involved. The invention now provides the reduction of these costs in such a way that the sanitation takes place right after the drying process.

Since the at least partially dried material is always removed from the plant near a collection point in any kind of way, the sanitization device is advantageously arranged right after this collection point. As a result of this, a fast treatment takes place in a small space and it is no longer necessary to transport the dried material to external sanitization equipment or to temporarily store it. In this case, the sanitization mainly takes care of killing the preferably pathogenic germs and other microorganisms living in the material.

The sanitization equipment can in this case be formed directly by—or be part of—the collection point. Thus, the material can be sanitized immediately after drying, in which case the advantage is that the drying heat that may still be present has not been lost in the meantime.

Advantageously, the drying plant consists of a convection and/or contact drying plant where the material is dried by applying the corresponding heating medium or by direct contact, e.g. through a heated wall or floor surface.

It is also advantageous if the plant is a solar drier because in this case drying is accomplished with solar energy. In this case, the drier is built similarly to a greenhouse for the optimal utilization of solar energy.

Furthermore, it is likewise advantageous for the plant to be a low-temperature or cold-air drying plant because such a plant can ensure gentle yet efficient drying.

It is also an advantage if the collection point and/or the sanitization device comprise a conveyor through which the material can be automatically or manually transported.

In this context, the conveyor comprises a screw conveyor, vibrator, blower, and/or conveyor belt, freely selectable depending on the plant design.

It is furthermore advantageous if the conveyor, collection point, and/or sanitization device can be heated from the interior and/or exterior so that the heat needed for sanitization is either directly supplied to the material or transferred to it through the corresponding structural walls.

In this case, the collection point, conveyor and/or sanitization device can include at least one own heat source that can be connected to a plant control system.

Here, it is also advantageous if the heat source comprises a heat pump, an electric heating element, an IR source, a heat exchange element, particularly for utilizing thermal energy from waste heat or especially a solar-heated heat carrier such as water or air, and/or a gas and/or oil burner. The choice of energy source can be freely selected, in which case the use of renewable energy sources is especially preferred.

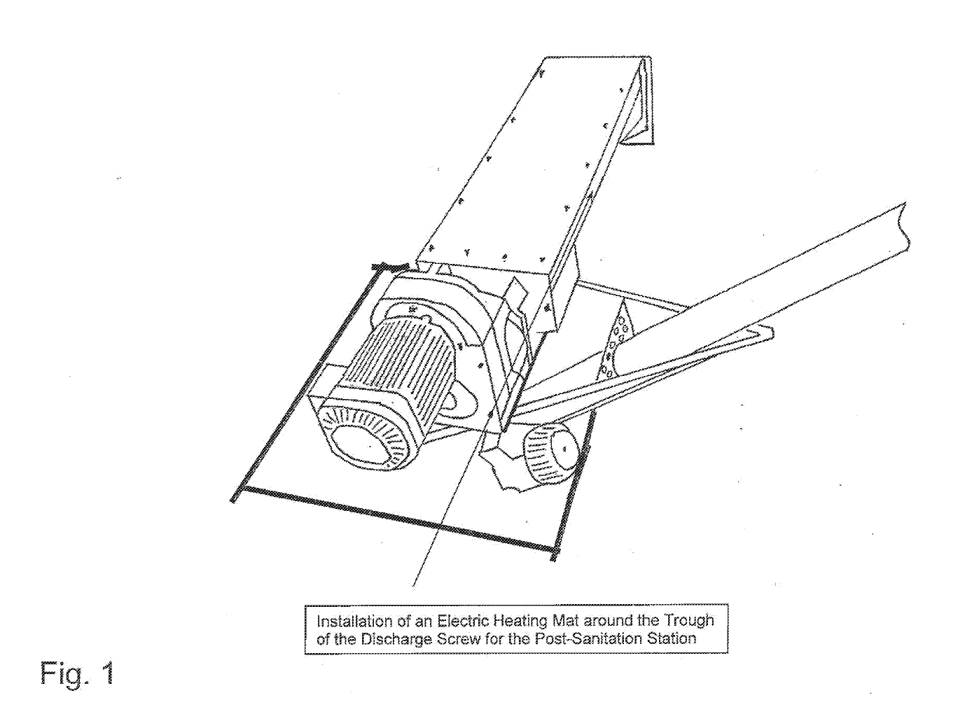

In addition, the heat source can include at least one heating rod, at least one heating coil and/or at least one heating mat for ensuring an optimal application of heat on the material. Here, the heating mat can surround the conveyor, for example, or also serve as direct contact surface for the material. For instance, FIG. 1 shows the trough of a corresponding screw conveyor arranged downstream from the collection point that at the same time can serve as conveyor and sanitization device. To accomplish this, the trough can be surrounded by the heating mat mentioned above, for example, so that sanitization takes place while the material is being moved out.

It is also advantageous for the sanitization device to have a receptacle through which air—especially heated air—can flow through. In this case, the receptacle can be arranged after the collection point, for example, and operated continuously or also batch-wise.

In any case, it is especially energy-efficient and advantageous if only small quantities of material are sanitized in order to reach a fast and, as far as possible, uniform heat distribution in the material.

Regarding the process, it is an advantage if the drying is done through convection and/or contact with the material to achieve an efficient drying.

The drying can also be done advantageously with low-temperature or cold-air to ensure a gentle drying of the material.

It is additionally highly advantageous if the material is sanitized near the material collection point. Such collection points are always available for taking away the at least partially dried material from the plant. Sanitization is particularly advantageous in this area, especially if the material has stored some drying heat. However, in low-temperature drying plants a sanitization in this area is also ideal for a fast and final treatment of the material without making use of long transportation routes.

For example, the material can also be sanitized in the area of a conveyor for the material using a vibrator, blower and/or conveyor belt, for example. Such devices are located most of the time in the area downstream from the drying surface anyway, so that a fast and efficient sanitization can take place here.

In this case, it is advantageous if the material is sanitized by the supply of heat from a heat source. Alternatively, other equipment such as UV radiators or devices known to the expert can be used, of course.

The heat source includes advantageously a heat pump, an electric heating element, an IR source, a heat exchanger element—especially for utilizing thermal energy from waste heat—or a heat carrier (especially solar-heated) such as water or air, and/or a gas and/or oil burner.

It is an advantage if the heat is supplied with at least one heating rod, heating coil and/or heating mat for ensuring a fast and efficient heating of the material.

Heat can also be supplied in a receptacle through which air (especially heated air) flows. As a result of this, the material can be heated to a temperature necessary for sanitization. On the other hand, the material can also be subsequently dried, thus allowing the comprehensive control of the entire process.

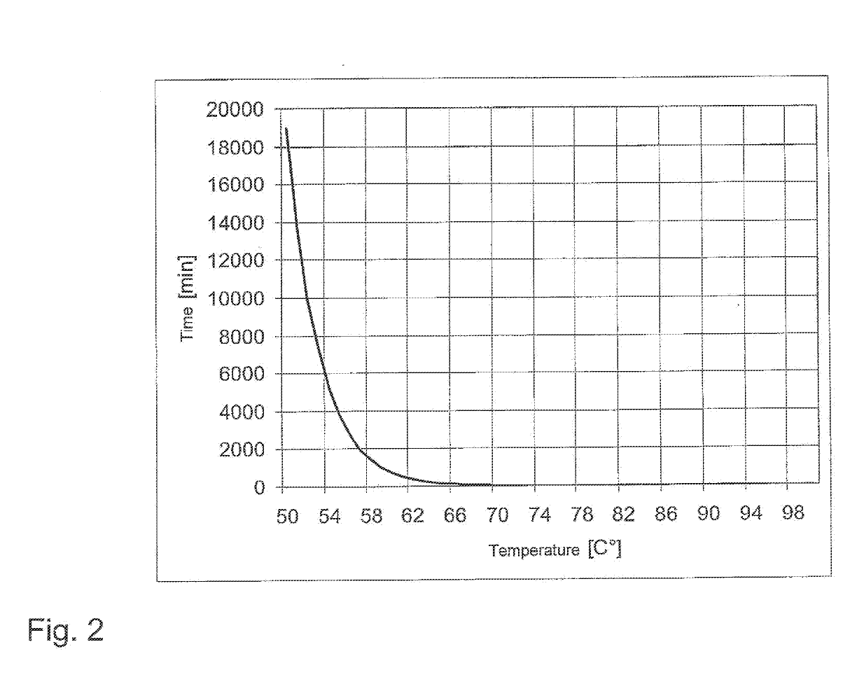

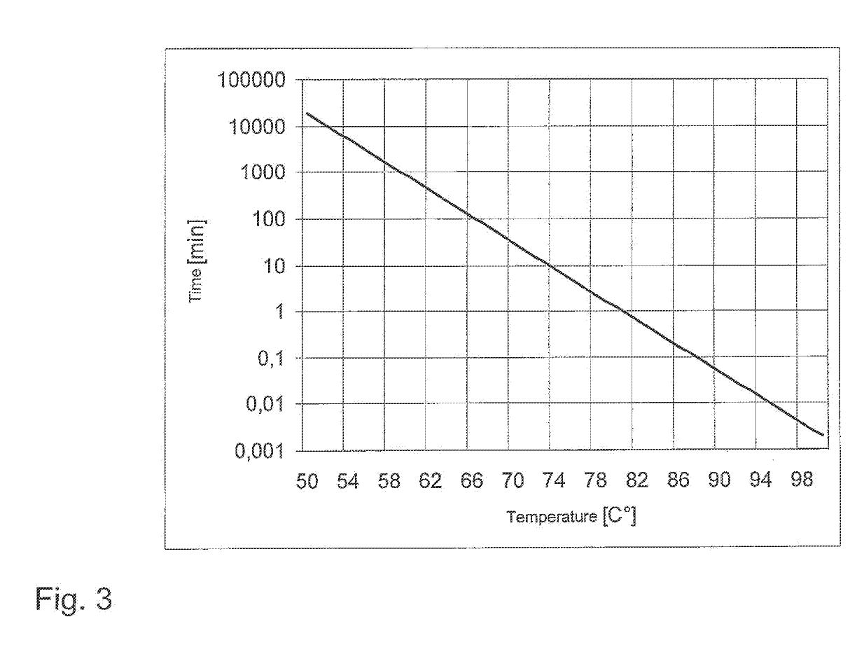

The sanitization should advantageously take place within a 40° C. to 90° C.—preferably 50° C. to 80° C.—temperature range, whereby the temperature depends not only largely from the quantity of material to be sanitized but also from the time it takes to sanitize it (between 5 and 120 minutes, preferably between 20 and 40 minutes). FIGS. 2 and 3 show the corresponding dependence between time and temperature; in FIG. 3, time has been plotted logarithmically. Practical experience has shown that a 70° C. sanitization over a 30-minute period is ideal.

Here, drying and/or sanitization takes place either continuously or batch-wise. Similarly, the corresponding processing technique can be controlled and regulated with the help of a control device and the respective sensors for determining the material's temperature and moisture continuously or also at regular intervals.

Incidentally, the invention is not restricted to the designs described above; rather, all combinations of the individual described characteristics, as shown or described in the claims, the description and the figures, are the subject matter of the invention as far as a corresponding combination is technically feasible or appears to be reasonable.

1. Plant for treating moist organic and/or inorganic material, especially having the form of sludge, such as sewage sludge for example, wherein the plant has a drying surface for the material to be treated and a collection point downstream therefrom for the at least partially dried material, characterized in that the plant has a device for sanitizing the material installed downstream from the drying surface.

2-25. (canceled)
